(19) United States
(12) Patent Application Publication
(10) Pub. No.: US 2006/0152890 A1
(43) Pub. Date: Jul. 13, 2006

(54) Gas-insulated switchgear

(76) Inventors: Kunio Yokokura, Tokyo (JP); Tetsu Shioiri, Saitama (JP); Osamu Sakaguchi, Tokyo (JP); Toshio Shimizu, Tokyo (JP); Masaru Miyagawa, Tokyo (JP); Susumu Kinoshita, Tokyo (JP); Satoshi Makishima, Tokyo (JP); Junichi Sato, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/311,219

(22) Filed: Dec. 20, 2005

(30) Foreign Application Priority Data
Dec. 22, 2004 (JP) P2004-370854

(51) Int. Cl. H02B 7/00

(52) U.S. Cl. 361/605

(57) ABSTRACT

A switchgear has an insulating container filled with an insulating gas, a fixed current-carrying shaft fixed airtightly to one opening of the insulating container, a fixed contact provided on an end of the fixed current-carrying shaft in the insulating container, a movable contact configured to separably contact the fixed contact, a movable current-carrying shaft having the movable contact provided on an end and airtightly movably penetrating the other opening of the insulating container, and an operation mechanism coupled with the movable current-carrying shaft at an outside of the insulating container. The insulating container is constituted by a plurality of insulating layers, and the insulating layers are higher in dielectric constant as closer to an inside of the insulating container.

### CROSS-REFERENCE TO RELATED APPLICATION

This application is based upon and claims the benefit of priority from the prior Japanese Application No. 2004-370854, filed on Dec. 22, 2004; the entire contents of which are incorporated herein by reference.

### BACKGROUND OF THE INVENTION

1. Field of the Invention

The present invention relates to a switchgear filled with an insulating gas between a pair of separable contacts. More specifically, the invention relates to a switchgear capable of improving withstand voltage characteristics between the contacts.

2. Description of the Related Art

A disconnect switch in a switchgear of this type is responsible for completely opening a power system circuit. For this reason, high withstand voltage characteristics are required between a pair of separable contacts.

To this end, as such a disconnect switch, there is conventionally known a disconnect switch filled with SF₆ gas excellent in dielectric strength (Japanese Patent Application Laid-open No. H5-227619). However, since the SF₆ gas is 2390 times as high in global warming potential as carbon dioxide, it should be strictly managed so as not to be leaked into the atmosphere. Furthermore, if the SF₆ gas is decomposed by arc, a toxic matter is produced.

Considering these, there is known a technique for using insulating gas excellent in dielectric strength and consisting of a carbon fluoride compound lower in global warming potential as a substitute for the SF₆ gas (Japanese Patent Application Laid-open No. 2003-169410). Nevertheless, even if this insulating gas is used, there still remains the disadvantage in that if the insulating gas is decomposed by arc, a toxic matter is produced.

There is also known a vacuum insulation type disconnect switch capable of ensuring excellent dielectric strength comparable to that of the insulating gas (Japanese Patent Application Laid-open No. 2001-176364). The vacuum insulation type disconnect switch has, however, the following disadvantages. A vacuum pressure is changed by vacuum leakage of a vacuum container that stores a pair of contacts, by emission of gaseous molecules attracted onto internal members of the vacuum container or the like. It is, therefore, necessary to manage degree of vacuum and the others, resulting in complicated structure.

On the other hand, there is known a technique for improving withstand voltage characteristics between contacts such as electrodes by providing an insulating coating film on one of the electrodes and setting a dielectric constant of this insulating coating film lower as closer to the other electrode (Japanese Patent Application Laid-open No. H11-262120). Although an electric field strength of the electrode on which the insulating film is provided can be suppressed, that of the other electrode without the insulating coating film cannot be greatly reduced. This disadvantageously makes it difficult to improve the withstand voltage characteristics between the electrodes. Besides, since it is necessary to contact the separable contacts employed in the switchgear with each other, it is disadvantageously difficult to provide the insulating coating film.

Namely, the conventional switchgears have the following disadvantages.

If the gas insulation type disconnect switch excellent in dielectric strength is employed so as to improve the withstand voltage characteristics between the paired separable contacts, the insulating gas influences global warming. To prevent this, it is required to manage the insulating gas so as not to be leaked into the atmosphere. The vacuum insulation type disconnect switch that does not use the insulating gas or the like at all is complicated in the structure of the switchgear. In addition, even if the insulating coating film having the dielectric constant changed is to be formed on the contact, it is difficult to do so because of necessity to contact the paired contacts with each other.

Conventionally, therefore, it has been desired to realize a switchgear capable of ensuring high withstand voltage characteristics while using insulating gas that does not produce any toxic matter and that is in harmony with the environment.

### SUMMARY OF THE INVENTION

The present invention has been achieved to solve the conventional disadvantages. Therefore, it is an object of the present invention to provide a switchgear capable of improving withstand voltage characteristics while using insulating gas harmonized with the environment.

To attain this object, the present invention provides a switchgear including: a cylindrical insulating container filled with an insulating gas; a fixed current-carrying shaft airtightly fixed to one opening of the insulating container; a fixed contact provided on an end of the fixed current-carrying shaft in the insulating container; a movable contact configured to separably contact the fixed contact; a movable current-carrying shaft having the movable contact provided on an end and airtightly movably penetrating the other opening of the insulating container; and an operation mechanism coupled with the movable current-carrying shaft at an outside of the insulating container, wherein the insulating container includes a plurality of insulating layers, the plurality of insulating layers being higher in dielectric constant as closer to an inside of the insulating container.

According to the present invention, the paired separable contacts employed in the switchgear are stored in the insulating container with the dielectric constant of which being higher as closer to the inside of the container, and the insulating gas is filled in the container. It is, therefore, possible to suppress an electric field strength of the inner surface of the insulating container and that of the contacts, and improve the withstand voltage characteristics.

### BRIEF DESCRIPTION OF THE DRAWINGS

FIG. 1 is a cross-sectional view of a configuration of a switchgear according to a first embodiment of the present invention;

FIG. 2 is a characteristic chart of a relationship between an electric field strength and a dielectric constant of the switchgear according to the first embodiment;

FIG. 3 is a characteristic chart of a relationship between the electric field strength and an insulation thickness of the switchgear according to the first embodiment; and

FIG. 4 is a cross-sectional view of a switching unit of a switchgear according to a second embodiment of the present invention.

### DESCRIPTION OF THE PREFERRED EMBODIMENTS

Embodiments of the present-invention will be explained below with reference to the accompanying drawings.

### First Embodiment

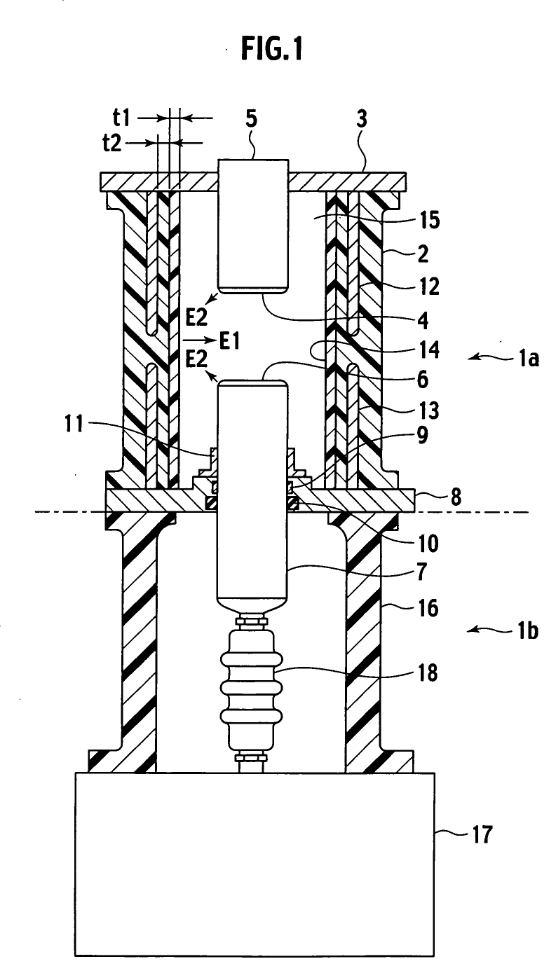

A switchgear according to a first embodiment of the present invention will be explained first with reference to FIGS. 1 to 3.

As shown in FIG. 1, a disconnect switch in a switchgear according to this embodiment is configured such that a switching unit la that is provided in an upper portion of the disconnect switch and that opens or closes a main circuit, and an operation unit 1b that is provided in a lower portion thereof and that operates the switching unit 1a are separately provided.

The switching unit 1a includes a cylindrical first insulating container 2 molded with an insulating material such as epoxy resin. An upper conductor 3, which serves as one electric path, is airtightly fixed to an opening on one end of the first insulating container 2. A fixed current-currying shaft 5 having a fixed contact 4 provided on an internal end of the first insulating container 2 is fixed to a generally central portion of the upper conductor 3. A movable contact 6 is provided on an end of a movable current-carrying shaft 7 to face the fixed contact 4. The movable contact 6 is capable to separably come in contact with the fixed contact 4.

The movable current-carrying shaft 7 movably penetrates a generally central portion of a lower conductor 8, one side surface of which is airtightly fixed to an opening of the other end of the first insulating container 2 and which serves as the other electric path. A contact 9, which is provided in a portion penetrating the lower conductor 8, slidably contacts with the movable current-carrying shaft 7, and the movable current-carrying shaft 7 can be kept airtightly by an O-ring 10. A guide cylinder 11 is provided so as to be able to axially move the movable current-carrying shaft 7.

A first shield electrode 12 equal in potential to the fixed current-carrying shaft 5 is embedded in an insulating layer of the first insulating container 2 so as to surround the fixed contact 4. A second shield electrode 13 equal in potential to the movable current-carrying shaft 7 is embedded in the insulating layer of the first insulating container 2 so as to surround the movable contact 6 and to be away from the first shield electrode 12 at a predetermined distance.

An insulating layer 14 formed by mixing high dielectric constant dielectric powder such as barium titanate with an insulating material such as epoxy resin is provided on an inner surface of the first insulating container 2. This insulating layer 14 can be high dielectric constant dielectric ceramic consisting of, for example, barium titanate. A dielectric constant of this insulating layer 14 can be thereby set higher than that of the first insulating container 2.

Insulating gas 15 such as anyone of dry air, carbon dioxide, and nitrogen gas present in the atmosphere and harmonized with the environment is filled into the first insulating container 2 provided with the insulating layer 14 from a filler valve (not shown) at a pressure (positive pressure) higher than an atmospheric pressure. This pressure is preferably increased within a range in which a mechanical strength of the first insulating container 2 is allowed since a dielectric strength of the insulating gas 15 itself can be improved.

The operation unit 1b includes a cylindrical second insulating container 16 molded with an insulating material such as epoxy resin. An opening of one end of the second insulating container 16 is fixed to the other side surface of the lower conductor 8. An operation mechanism 17 such as an electromagnetic actuator is attached to an opening on the other end of the second insulating container 16. An insulating operation rod 18 is coupled with the operation mechanism 17 in an axial direction of the movable current-carrying shaft 7 so as to be able to open or close a part between the contacts 4 and 6.

The relationship among the insulating layer 14, the first insulating container 2, the first shield electrode 12, and the second shield electrode 13 will be explained. It is assumed herein that a dielectric constant of the insulating layer 14 is ε1, an insulation thickness of the insulating layer 14 is t1, a dielectric constant of the first insulating container 2 is ε2, and an insulation thickness of the first insulating container 2 from the first shield electrode 12 and the second shield electrode 13 to the insulating layer 14 is t2. It is noted that an insulating container that stores the contacts 4 and 6 can be configured so that the insulating layer 14 serves as an inner insulating layer and that the first insulating container 2 serves as an outer insulating layer.

A ratio of the dielectric constant ε1 of the insulating layer 14, which serves as the inner insulating layer, to the dielectric constant ε2 of the first insulating container 2, which serves as the outer insulating layer is set to ε1/ε2=2 to 30.

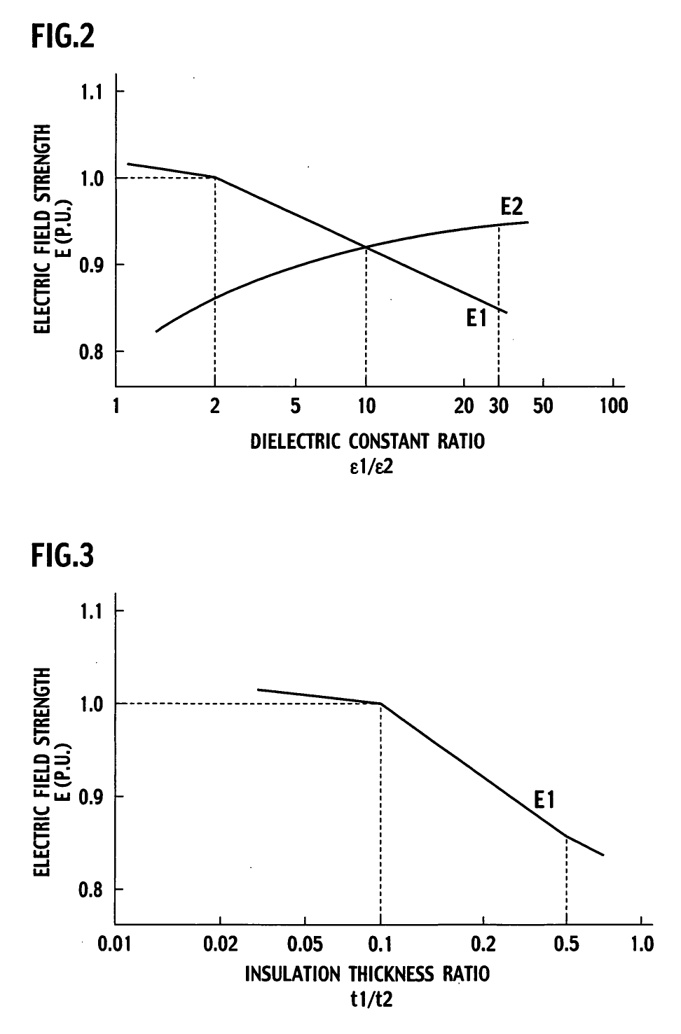

The reason for so setting is as follows. As shown in FIG. 2, if the dielectric constant ratio ε1/ε2 is higher, an electric field strength ε1 of a surface of the insulating layer 14 tends to be lower. However, if the dielectric constant ratio ε1/ε2 is equal to or higher than 2, the electric field strength ε1 is rapidly reduced, so that the effect of suppressing the electric field grows. If the dielectric constant ratio ε1/ε2 exceeds 30, the electric field suppression effect remains; however, a filling quantity of the high dielectric constant dielectric powder mixed with the insulating material for forming the insulating layer 14 is increased. As a result, the mechanical strength of the first insulating container 2 as a structure is reduced.

If the dielectric constant ratio ε1/ε2 is increased, the effect of suppressing the electric field of the surface of the insulating layer 14 can be produced. Conversely, however, an electric field strength E2 of the fixed contact 4 and the movable contact 6 is increased. This is because an equipotential spread by the insulating layer 14 is closer near the fixed contact 4 and the movable contact 6.

Generally, the contacts 4 and 6 are each formed so that a radius of curvature of an end thereof is several millimeters. The electric field strength E2 of the contacts 4 and 6 is equal to the electric field strength El at a point where the dielectric constant ratio ε1/ε2 is 10. Due to this, at the point where the dielectric constant ratio ε1/ε2 of the insulating layer 14 to the first insulating container 2 is 10, both the electric field strength E1 of the surface of the insulating layer 14 and the electric field strength E2 of the contacts 4 and 6 are suppressed, thereby providing an optimum dielectric constant ratio.

The dielectric constant of the first insulating container 2 is about four, if the first insulating container 2 consists of ordinary epoxy resin. The dielectric constant of barium titanate mixed with the insulating layer 14 is equal to or higher than 1000. Therefore, the dielectric constant ratio ε1/ε2 can be easily set to the optimum ratio.

A ratio t1/t2 of the insulation thickness t1 of the insulating layer 14, which serves as the inner insulating layer, to the insulation thickness t2 of the first insulating container 2, which serves as the outer insulating layer, from the shield electrodes 12 and 13 to the insulating layer 14 is set to 0.1 to 0.5.

The reason for so setting is as follows. As shown in FIG. 3, if the insulation thickness ratio t1/t2 is higher, the electric field strength E1 of the surface of the insulating layer 14 tends to be lower. However, if the insulation thickness ratio t1/t2 is equal to or higher than 0.1, the electric field strength E1 is suddenly reduced and the effect of suppressing the electric field largely grows. If the insulation thickness ratio t1/t2 is lower than 0.1, the insulation thickness t1 of the insulating layer 14 is excessively small. As a result, the electric field suppression effect is reduced.

If the insulation thickness ratio t1/t2 exceeds 0.5, a reduction in the electric field strength E1 is gentler. If the insulation thickness ratio t1/t2 exceeds 0.5, a gap between the contacts 4 and 6 and the insulating layer 14 is unfavorably narrowed. If so, metal steam generated when opening or closing the part between the contacts 4 and 6 is insufficiently diffused.

The switchgear according to the first embodiment stores the fixed contact 4 and the movable contact 6 in the first insulating container 2, and includes the insulating layer 14 provided on the inner surface of this first insulating container 2 and higher in dielectric constant than the first insulating container 2. It is, therefore, possible to suppress the electric field strength of the surface of the insulating layer 14 and that of the contacts 4 and 6, and improve the withstand voltage characteristics.

In the first embodiment, the instance in which the first and the second shield electrodes 12 and 13 are embedded in the first insulating container 2 has been explained. However, the electric field strength of the inner surface of the insulating layer 14 and that of the contacts 4 and 6 can be suppressed as long as the dielectric constant of the insulating layer 14 is set higher than that of the first insulating container 2 without need to embed the first and the second shield electrodes 12 and 13 therein.

### Second Embodiment

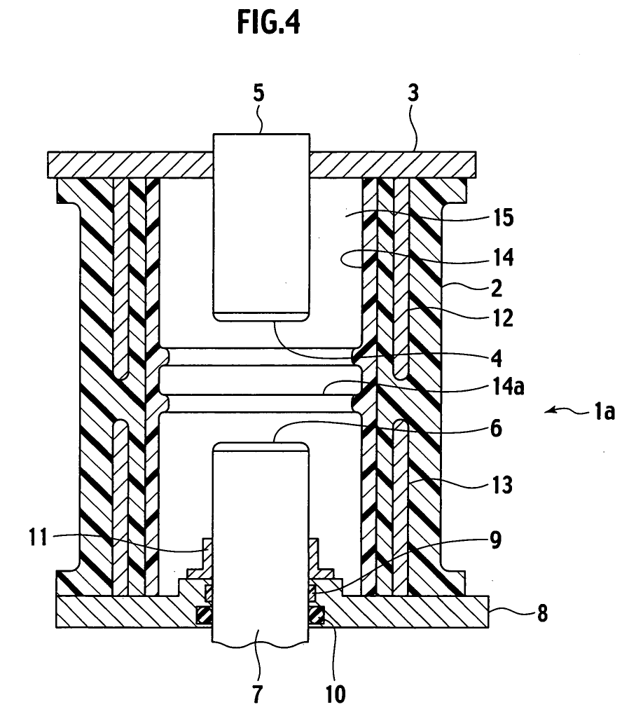

A switchgear according to a second embodiment of the present invention will be explained with reference to FIG. 4. FIG. 4 is a cross-sectional view of a switching unit of the switchgear according to the second embodiment of the present invention. The second embodiment differs from the first embodiment in that protrusions are provided on an insulating layer. In FIG. 4, like constituent elements as those shown in FIG. 1 are designated with like reference numerals and will not be repeatedly explained.

As shown in FIG. 4, the insulating layer 14 consisting of an insulating material higher in dielectric constant than the first insulating container 2 is provided on the inner surface of the first insulating container 2. A plurality of annular protrusions 14a protruding inward are provided on this insulating layer 14.

The switchgear according to the second embodiment enables an increase in a creeping distance of an inner surface of the insulating layer 14 as well as the advantages of the first embodiment. It is, therefore, possible to improve the with stand voltage characteristics between the upper conductor 3 and the lower conductor 8.

The present invention is not limited to the above embodiments, and various changes and modifications can be made within the scope of the invention. In the above embodiments, the instance where two insulating layers different in dielectric constant are employed has been explained. Alternatively, an insulating container constituted by two or more, i.e., a plurality of insulating layers higher in dielectric constant as closer to an inside of the container can be provided, and a pair of separable contacts can be stored in this insulating container. Such an insulating container can be formed by sequentially casting the insulating layers from outside or inside by multiple casting using, for example, a mold having an inside diameter and an outside diameter different from each other. Furthermore, a grounding layer can be provided on an outer periphery of the insulating container so as to improve the pollution characteristics.

What is claimed is:

1. A switchgear comprising:
a cylindrical insulating container filled with an insulating gas;
a fixed current-carrying shaft airtightly fixed to one opening of the insulating container;
a fixed contact provided on an end of the fixed current-carrying shaft in the insulating container;
a movable contact configured to separably contact the fixed contact;
a movable current-carrying shaft having the movable contact provided on an end and airtightly movably penetrating the other opening of the insulating container; and
an operation mechanism coupled with the movable current-carrying shaft at an outside of the insulating container, wherein
the insulating container includes a plurality of insulating layers, the plurality of insulating layers being higher in dielectric constant as closer to an inside of the insulating container.

2. The switchgear according to claim 1, wherein
the insulating container includes two insulating layers of an outer insulating layer and an inner insulating layer, and
a first shield electrode and a second shield electrode are embedded in the outer insulating layer, the first shield electrode surrounding the fixed contact and being equal in potential to the fixed contact, the second shield electrode surrounding the movable contact, being away from the first shield electrode, and being equal in potential to the movable contact.

3. The switchgear according to claim 2, wherein
if a dielectric constant of the inner insulating layer is ε1 and a dielectric constant of the outer insulating layer is ε2, a dielectric constant ratio ε1/ε2 is set to 2 to 30.

4. The switchgear according to claim 2, wherein
if an insulation thickness of the inner insulating layer is t1 and an insulation thickness of the outer insulating layer from the first shield electrode and the second shield electrode to the inner insulating layer is t2, an insulation thickness ratio t1/t2 is set to 0.1 to 0.5.

5. The switchgear according to claim 2, further comprising:
protrusions protruding toward an inner surface of the inner insulating film.

6. The switchgear according to claim 1, wherein
the insulating gas includes any one of air, carbon dioxide, and nitrogen gas.
